(19) United States
(12) Patent Application Publication
(10) Pub. No.: US 2023/0115206 A1
(43) Pub. Date: Apr. 13, 2023

(54) SIGN DETECTION DEVICE AND SIGN DETECTION METHOD

(71) Applicants: MITSUBISHI HEAVY INDUSTRIES, LTD., Tokyo (JP); Tokyo University of Science Foundation, Tokyo (JP)

(72) Inventors: Tomohito NAKAMORI, Tokyo (JP); Keisuke MATSUYAMA, Tokyo (JP); Takuya KUROSAKA, Tokyo (JP); Hiroshi GOTODA, Tokyo (JP); Natsumi KIKUTA, Tokyo (JP)

(73) Assignees: MITSUBISHI HEAVY INDUSTRIES, LTD., Tokyo (JP); Tokyo University of Science Foundation, Tokyo (JP)

(21) Appl. No.: 17/960,314

(22) Filed: Oct. 5, 2022

(30) Foreign Application Priority Data
Oct. 11, 2021 (JP) 2021-167063

(51) Int. Cl. G01M 15/14; F01D 17/02

(52) U.S. Cl. CPC G01M 15/14; F01D 17/02; F05D 2220/323; F05D 2260/80; F05D 2270/334

(57) ABSTRACT

A sign detection device is provided with a plurality of sensors, a data acquisition unit, a calculation unit, and a detection unit. The plurality of sensors are respectively disposed at a plurality of positions of a detection target to measure a physical parameter at each positions.

The data acquisition unit is configured to acquire time-series change data of the physical parameters from the plurality of sensors. The calculation unit is configured to calculate dynamic network information representing a time change of a complex network structure including a parameter indicating a correlation between the physical parameters at any two positions of the plurality of positions, on the basis of the time-series change data. The detection unit is configured to detect a sign of sudden change vibration of the detection target, on the basis of the dynamic network information.

### TECHNICAL FIELD

The present disclosure relates to a sign detection device and a sign detection method for detecting a sign of sudden change vibration.

### BACKGROUND

In machines such as gas turbines, steam turbines, engines, boilers, aircraft, and compressors, combustion vibrations and shaft vibrations may occur in combustors, compressors, blades, and the like. Of these vibrations, unstable vibration with a tendency to change suddenly (sudden change vibration) reaches the limit cycle in a short time after the vibration increase occurs. Reaching the limit cycle may result in a trip or a heavy load on devices.

Therefore, it is desirable to avoid such sudden change vibration at an early stage. However, since the vibration increase until the limit cycle is reached is short-lived, control after detecting the vibration increase may not be able to avoid the sudden change vibration. In order to avoid the sudden change vibration, it is necessary to detect a sign of this vibration well in advance of its occurrence.

In recent years, detection techniques aimed at detecting sudden change vibration in advance have been proposed. For example, Patent Document 1 discloses a device for detecting combustion oscillation using a value related to pressure in a gas turbine combustor. This device is configured to acquire a value related to pressure in a gas turbine combustor, calculate network entropy, and detect the occurrence of combustion oscillation when the network entropy falls below a threshold.

### CITATION LIST

### Patent Literature

Patent Document 1: JP2018-80621A

### SUMMARY

As a result of intensive studies by the present inventors, it has been found that a correlation between physical parameters (e.g., pressures) at a plurality of positions is important in detecting a sign of sudden change vibration. By using a parameter indicating such a correlation, it is possible to detect a sign of sudden change vibration.

However, even if the network entropy is calculated by acquiring time-series change data of a physical parameter (value related to pressure in combustor) at one position as in Patent Document 1, since the correlation between physical parameters at a plurality of positions is not taken into account, it is difficult to detect a sign of sudden change vibration well in advance of its occurrence.

The present disclosure was made in view of the above circumstances, and an object thereof is to provide a sign detection device and a sign detection method whereby it is possible to detect sudden change vibration well in advance of the occurrence of sudden change vibration.

A sign detection device according to the present disclosure is provided with: a plurality of sensors respectively disposed at a plurality of positions of a detection target, and configured to measure a physical parameter at each of the plurality of positions; a data acquisition unit configured to acquire time-series change data of the physical parameters from the plurality of sensors; a calculation unit configured to calculate dynamic network information representing a time change of a complex network structure including a parameter indicating a correlation between the physical parameters at any two positions of the plurality of positions, on the basis of the time-series change data; and a detection unit configured to detect a sign of sudden change vibration of the detection target, on the basis of the dynamic network information.

A sign detection method according to the present disclosure includes: a step of, with a plurality of sensors respectively disposed at a plurality of positions of a detection target, measuring a physical parameter at each of the plurality of positions; a step of acquiring time-series change data of the physical parameters from the plurality of sensors; a step of calculating dynamic network information representing a time change of a complex network structure including a parameter indicating a correlation between the physical parameters at any two positions of the plurality of positions, on the basis of the time-series change data; and a step of detecting a sign of sudden change vibration of the detection target, on the basis of the dynamic network information.

The present disclosure provides a sign detection device and a sign detection method whereby it is possible to detect sudden change vibration well in advance of the occurrence of sudden change vibration.

### BRIEF DESCRIPTION OF DRAWINGS

FIG. 1 is a block configuration diagram of the sign detection device according to an embodiment.

FIG. 2 is a schematic diagram showing an arrangement example of sensors of the sign detection device according to an embodiment.

FIG. 3 is a schematic cross-sectional view showing an arrangement example of sensors of the sign detection device according to an embodiment.

FIG. 4 is a diagram showing an adjacency matrix based on physical parameters acquired by the data acquisition unit at each time.

FIG. 5 is a diagram showing an example of conversion operation from an adjacency matrix to a vector.

FIG. 6 is a diagram showing high-dimensional vectors calculated as time progresses.

FIG. 7 is an example of sample data showing changes over time in link strength representing the strength of each link in a complex network calculated based on physical parameters acquired from the sensors 200.

FIG. 8 is a diagram showing a data distribution obtained by expanding the sample data of FIG. 7 into a high-dimensional space.

FIG. 9 is an example of a result of clustering changes over time in high-dimensional vector by the detection unit.

FIG. 10 is a flowchart of procedure of the sign detection method according to an embodiment.

### DETAILED DESCRIPTION

Embodiments will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention.

(Sign Detection Device)

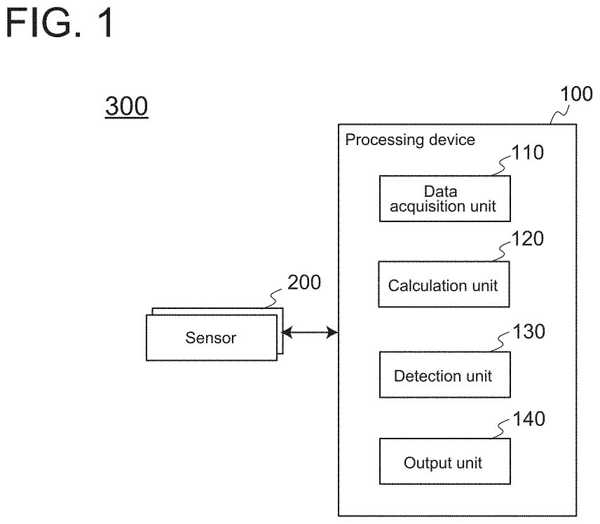

A sign detection device 300 according to an embodiment will now be described. FIG. 1 is a block configuration diagram of the sign detection device 300 according to an embodiment.

As shown in FIG. 1, the sign detection device 300 includes a plurality of sensors 200 and a processing device 100 configured to execute processing for detecting a sign of sudden change vibration. Each sensor 200 is configured to measure a physical parameter of a detection target.

The plurality of sensors 200 are disposed at a plurality of positions of the detection target, respectively, to measure a physical parameter at each position. The physical parameter measured by the sensor 200 is, for example, one or more of pressure, strain, acceleration, velocity, and displacement. However, the physical parameter measured by the sensor 200 is not limited to these physical parameters. The physical parameter measured by the sensor 200 may be any physical parameter that is highly related to the occurrence of combustion oscillation.

The processing device 100 is, for example, a computer including a central processing unit (CPU), a random access memory (RAM), and a read only memory (ROM). In the processing device 100, the processor (CPU) executes programs stored in the memory (RAM or ROM) to implement functions described later.

Hereinafter, a functional configuration of the processing device 100 will be described. As shown in FIG. 1, the processing device 100 functions as a data acquisition unit 110, a calculation unit 120, a detection unit 130, and an output unit 140.

The data acquisition unit 110 is configured to acquire time-series change data of physical parameters from the plurality of sensors 200. The time-series change data is measurement data sampled at multiple timings (e.g., 100 or more timings) per unit time (e.g., 1 second) in the most recent past.

The calculation unit 120 is configured to calculate dynamic network information on the basis of the time-series change data of the physical parameters acquired by the data acquisition unit 110. The dynamic network information represents changes over time in a complex network structure including a parameter indicating a correlation. The parameter indicating a correlation is a parameter indicating a correlation between physical parameters at any two positions of the plurality of positions where the sensors 200 are arranged.

The detection unit 130 is configured to detect a sign of sudden change vibration of a detection target on the basis of the dynamic network information calculated by the calculation unit 120. The detection result of the detection unit 130 is output from the output unit 140 in any form. The output form from the output unit 140 may be, for example, image data showing the vibration state of the detection target, or audio data (e.g., a voice announcing a sign of sudden change vibration) of an audio output device such as a speaker.

Further, the output unit 140 may be configured to output a predetermined signal when the detection unit 130 detects a sign of sudden change vibration. The predetermined signal is, for example, a signal effective for avoiding sudden change vibration, such as a stop signal for stopping the operation of the detection target, an output control signal for reducing the output of the detection target, or a notification signal for notifying the user of a sign of sudden change vibration.

Further, the output unit 140 may be configured to output information about maintenance estimated from the parameter indicating the correlation. The information about maintenance includes, for example, parts to be replaced, the recommended replacement time, and the presence or absence of failure. Such image data, predetermined signal, and information about maintenance are generated based on, for example, the calculation result of the calculation unit 120 or the detection result of the detection unit 130.

(Arrangement Example of Sensors and Detection Target)

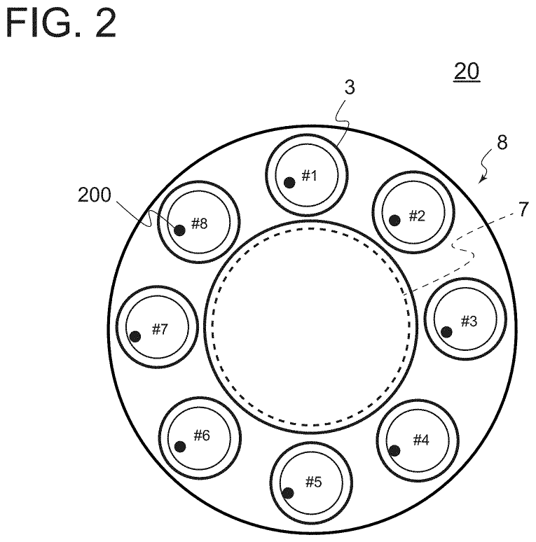

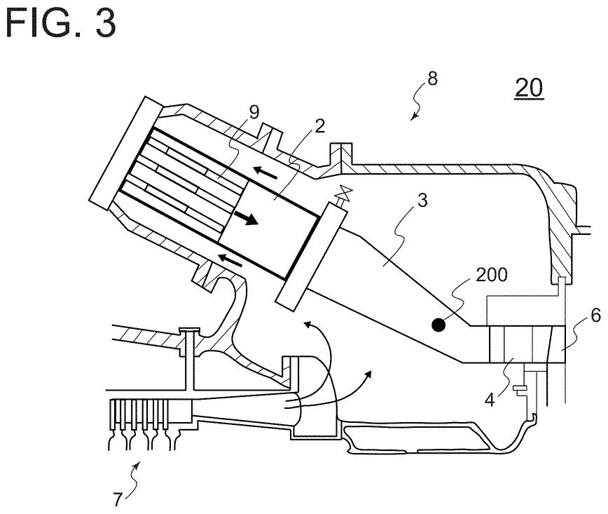

Hereinafter, an arrangement example of the sensors 200 and the detection target according to an embodiment will be described. FIG. 2 is a schematic diagram showing an arrangement example of the sensors 200 of the sign detection device 300 according to an embodiment. This figure shows a cross-section along a direction perpendicular to the turbine axis of the gas turbine 20. FIG. 3 is a schematic cross-sectional view showing an arrangement example of the sensors 200 of the sign detection device 300 according to an embodiment. This figure shows a cross-section along the turbine axis of the gas turbine 20.

In an embodiment, the detection target of the sign detection device 300 may be, for example, the gas turbine 20 shown in FIGS. 2 and 3. The detection target may be not the gas turbine 20 but a machine such as a steam turbine, an engine, a boiler, an aircraft, or a compressor.

As shown in FIGS. 2 and 3, the gas turbine 20 includes a compressor 7, a combustor 8, a stator vane 4, and a rotor blade 6. As shown in FIG. 2, the combustor 8 includes eight can combustors. In FIG. 2, the eight can combustors are numbered #1 to #8 according to their positions. As shown in FIG. 3, the eight can combustors each have a fuel nozzle 9, a combustor basket 2, and a transition piece 3. Each sensor 200 is a pressure sensor for measuring the pressure inside the combustor 8. The sensor 200 is arranged in each of the eight transition pieces 3.

In this example, the sensors 200 are arranged at the transition pieces 3 of the combustor 8 of the gas turbine 20. However, the arrangement of the sensors 200 is not limited to this example. The sensors 200 may be arranged at any positions where the vibration mode can be observed, and may be arranged at a compressor, a blade, a bearing, or the like, depending on the type of detection target.

(Specific Example of Dynamic Network Information)

Hereinafter, a specific example of the dynamic network information to be calculated by the calculation unit 120 will be described.

First, the correlation between physical parameters corresponding to the positions of the plurality of sensors 200 acquired by the data acquisition unit 110 will be described.

According to the present inventors, the correlation between physical parameters can be interpreted as an undirected weighted complex network in which the plurality of positions are nodes. For example, the correlation between physical parameters can be expressed as an adjacency matrix A (A is expressed in bold to indicate a vector; the same applies hereinafter).

As shown in the following expression (1), the adjacency matrix A is defined as an nxn square matrix. In the adjacency matrix A, a matrix element wᵢⱼ indicates the correlation between the i-th physical parameter and the j-th physical parameter. n corresponds to the number of physical parameters (i.e., the number of sensors 200).

$$A = ( \begin{matrix}{w}_{11} & ⋯ & {w}_{1 n} \\ ⋮ & ⋱ & ⋮ \\ {w}_{n 1} & ⋯ & {w}_{n n}\end{matrix} ) \qquad ( 1 )$$

In the adjacency matrix A, the diagonal components w₁₁, w₂₂, . . . wₙₙ are zero, and matrix elements other than the diagonal components are values indicating the magnitude of correlation coefficients (the matrix element in row i, column j is the absolute value of correlation coefficient Cᵢⱼ). In other words, a matrix element representing the relation between physical parameters at different positions is the absolute value of correlation coefficient C_{if}, and a matrix element representing the relation between physical parameters at the same position is zero. Further, correlation coefficients with row and column indices reversed are basically the same. For example, w₂₄ and w₄₂ have the same value.

In the arrangement example of the sensors 200 shown in FIG. 2, since there are eight nodes #1 to #8, the adjacency matrix A is an 8×8 square matrix. For example, the correlation between physical parameters measured in the #2 can combustor and the #4 can combustor is the matrix element w₂₄, i.e., the absolute value of correlation coefficient C₂₄.

The parameter indicating the correlation may be the correlation coefficient Cᵢⱼ indicating the correlation of changes in the physical parameter at each position. The correlation coefficient Cᵢⱼ is represented by the following expression (2), for example. The expression (2) shows the example where the physical parameter is pressure, but the physical parameter may be other than pressure.

$${C}_{ij} = \frac{{\sum }_{t = {t}_{1}}^{{t}_{N}} ( {p}_{i} ( t ) - {P}_{i} ) ( {p}_{j} ( t ) - {P}_{j} )}{\sqrt{{\sum }_{t = {t}_{1}}^{{t}_{N}} {( {p}_{i} ( t ) - {P}_{i} )}^{2}} \sqrt{{\sum }_{t = {t}_{1}}^{{t}_{N}} {( {p}_{j} ( t ) - {P}_{j} )}^{2}}} \qquad ( 2 )$$

Here, N is the number of samples (e.g., 100 or more) per unit time (e.g., 1 second). pᵢ(t) indicates the instantaneous value of pressure at the i-th position, and pⱼ(t) indicates the instantaneous value of pressure at the j-th position. Pᵢ is the time average value of pᵢ(t) per unit time, and Pⱼ is the time average value of pⱼ(t) per unit time. The instantaneous value or time average value of change in pressure may be used instead of the instantaneous value or time average value of pressure.

The correlation coefficient Cᵢⱼ is close to 1 or −1 when there is a correlation between physical parameters at two positions, and close to 0 when there is no correlation. Further, the absolute value of correlation coefficient Cᵢⱼ is within the range of 0 to 1. Thus, the strength of correlation can be determined from the absolute value of correlation coefficient Cᵢⱼ. However, the correlation coefficient Cᵢⱼ is not limited to the calculated value shown by the expression (2). It can be modified as appropriate within a range that does not impair the essential significance.

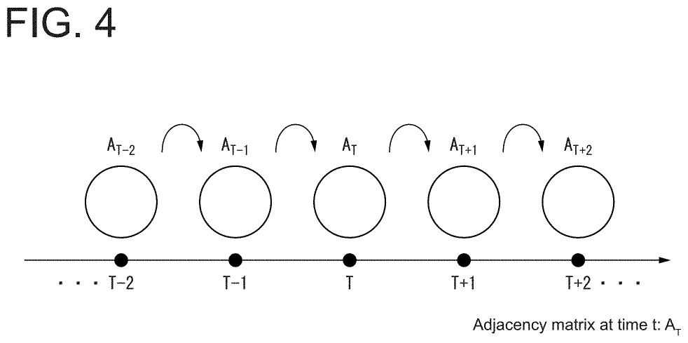

FIG. 4 is a diagram showing an adjacency matrix A based on physical parameters acquired by the data acquisition unit 110 at each time. Defining A_{T} as the adjacency matrix A based on physical parameters acquired by the data acquisition unit 110 at times ti to tN, the adjacency matrices A corresponding to times T−2, T−1, T, T+1, T+2 adjacent to time T are represented as A_{T-2}, A_{T-1}, A_{T}, A_{T+1}, A_{T+2}, respectively.

The interval between adjacent times (for example, time T and time T+1) in FIG. 4 corresponds to sampling time t_{N}.

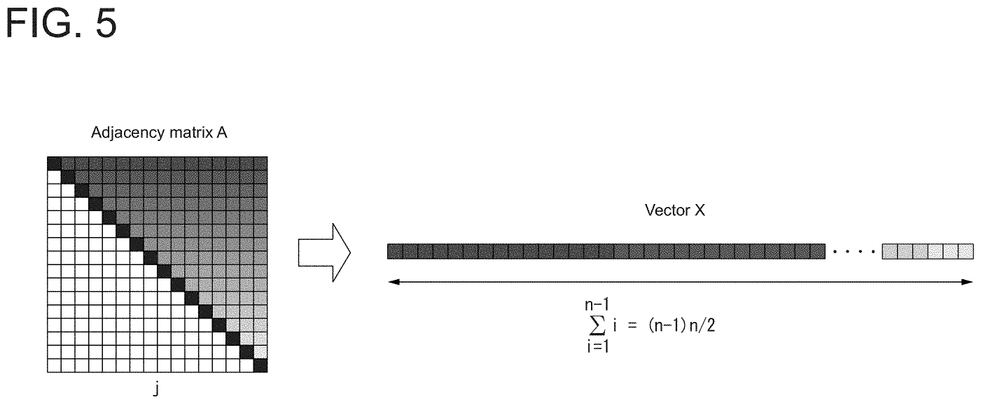

The calculation unit 120 converts the adjacency matrix A at each time into a vector X. FIG. 5 is a diagram showing an example of conversion operation from the adjacency matrix A to the vector X. The vector X is a vector whose components are matrix elements representing the relation between physical parameters at different positions among the matrix elements of the adjacency matrix A, and the number of dimensions of the vector is represented by the following expression (3). As described above, the absolute values of correlation coefficients Cᵢⱼ in the adjacency matrix A are used as components, and the dimension is represented by the following expression (3) with the number of nodes n in the network. As described above, the diagonal components w₁₁, w₂₂, . . . wₙₙ of the adjacency matrix A are zero, and matrix elements other than the diagonal components with row and column indices reversed have basically the same correlation coefficient. Therefore, as shown by gradations in FIG. 5, the vector X is obtained by arranging the matrix elements on one side of the diagonal components w₁₁, w₂₂, . . . wₙₙ as components.

Σᵢ₌₁ⁿ⁻¹i=(n−1)n/2 (3)

Such conversion from the adjacency matrix A to the vector X is performed for each of the adjacency matrices . . . , A_{T-2}, A_{T-1}, A_{T}, A_{T+1}, A_{T+2}, . . . , corresponding to each time. The vectors X corresponding to the adjacency matrices . . . , A_{T-2}, A_{T-1}, A_{T}, A_{T+1}, A_{T+2}, . . . , will be referred to as . . . , X_{T-2}, X_{T-1}, X_{T}, X_{T+1}, X_{T+2}, . . . , as appropriate.

Then, the calculation unit 120 constructs a high-dimensional vector G represented by the following expression (4) by connecting multiple adjacent vectors X. k is the number of connections of adjacent vectors X, and means the number of past points referred to in the dynamic network information.

G=[X_{T-k}, X_{T-k+1}, . . . , X_{T}] (4)

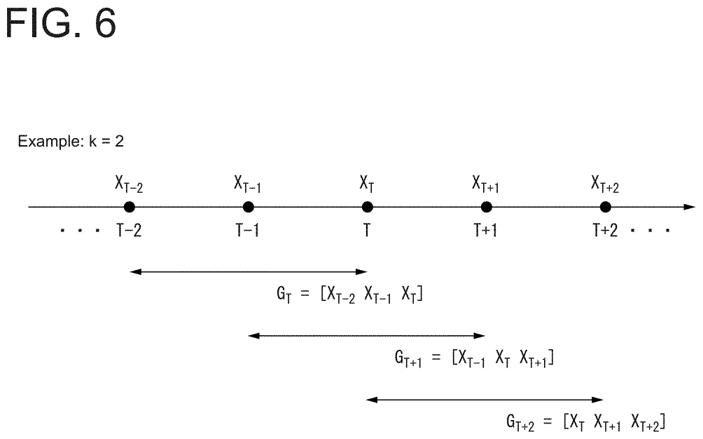

Such a high-dimensional vector G is sequentially calculated as time T progresses. FIG. 6 is a diagram showing high-dimensional vectors G calculated as time T progresses. In FIG. 6, the case where the number of connections k=2 is illustrated for ease of understanding, and the high-dimensional vector G_{T} calculated at time T is represented by [X_{T-2}, X_{T-1}, X_{T}], the high-dimensional vector G_{T+1} calculated at time T+1 is represented by [X_{T-1}, X_{T}, X_{T+1}], and the high-dimensional vector G_{T+2} calculated at time T+2 is represented by [X_{T}, X_{T+1}, X_{T+2}].

(Specific Example of Detection of Sign of Sudden Change Vibration)

The detection unit 130 detects a sign of sudden change vibration on the basis of the calculation result of the calculation unit 120. Hereinafter, a specific detection method will be described.

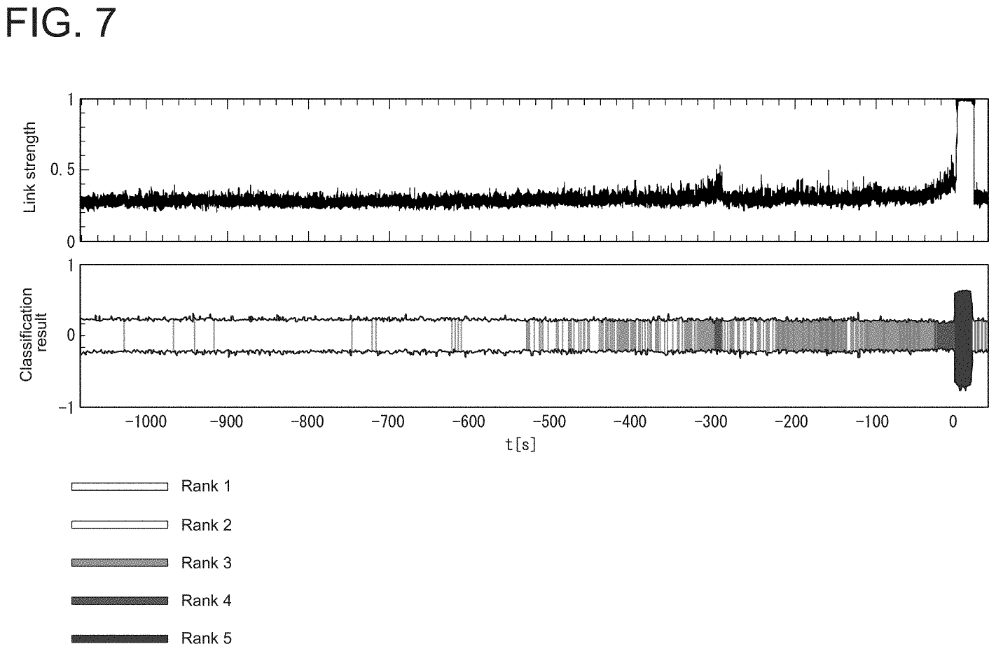

First, the detection unit 130 previously sets a determination criterion for determining a sign of sudden change vibration. Such a determination criterion is set by learning with sample data. FIG. 7 is an example of sample data showing changes over time in link strength representing the strength of each link in a network calculated based on physical parameters acquired from the sensors 200. In this example, the link strength remains relatively small during normal operation when no abnormality occurs in the detection target, but it tends to increase rapidly near time t=0 when the sudden change vibration occurs. This indicates that the link strength is effective as a parameter that suggests the possibility of the occurrence of sudden change vibration.

Therefore, the present inventors establish ranks for stepwise classification of the state of the detection target based on the high-dimensional vector G. In this embodiment, ranks 1 to 5 are set based on the high-dimensional vector G. The larger the number, the higher the possibility of the occurrence of sudden change vibration. FIG. 7 shows the results of classification of which ranks 1 to 5 each data point included in the time-varying high-dimensional vector G belongs to.

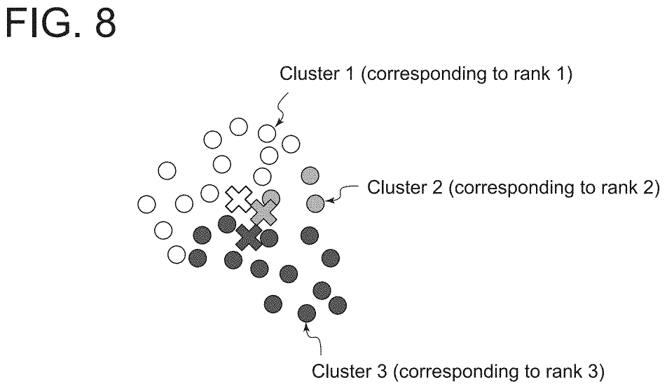

The detection unit 130 identifies a cluster for each rank by expanding each data point included in the high-dimensional vector G thus classified into the ranks in a high-dimensional space. FIG. 8 is a diagram showing a data distribution obtained by expanding the sample data of FIG. 7 in a high-dimensional space. In FIG. 8, the high-dimensional space is shown as a two-dimensional plane for convenience, as shown on the paper.

In FIG. 8, data points of high-dimensional vectors G corresponding to three ranks 1 to 3 are typically indicated by different symbols, and data points of high-dimensional vectors G belonging to the same rank are grouped together in a predetermined range to form a cluster corresponding to that rank (the same applies to the other ranks 4 and 5, although the illustration is omitted for the clarity of explanation). The detection unit 130 previously prepares such data points that form a cluster corresponding to each rank as the determination criterion.

By increasing the number of sample data, the number of data points belonging to each cluster is increased, so such a determination criterion is effective in improving the determination accuracy.

Then, the detection unit 130 detects a sign of sudden change vibration, using the determination criterion set as described above, on the basis of the high-dimensional vector G calculated by the calculation unit 120. Such detection of a sign of sudden change vibration is performed by identifying which of the clusters defined by the determination criterion the data point corresponding to the high-dimensional vector G calculated by the calculation unit 120 is classified into. Such classification into clusters is called clustering, and includes, for example, the Ward method and support vector machine, etc. As an example, the case using the K-means method will be described.

In the K-means method, clustering is performed according to the following procedure, where m is the number of data contained in the high-dimensional vector G, and K is the number of clusters set by the determination criterion.

(i) Randomly assign clusters to each data xi (i=1, m).

(ii) Calculate the center Vj (j=1, K) of each cluster on the basis of the assigned data. (

iii) Find the distance between xi and each Vj and reassign xi to the cluster with the closest center.

(iv) If the assignment of all xi to the cluster does not change in the above process, or if the amount of change falls below a predetermined threshold, it is determined that convergence has occurred and the process ends. If the condition (iv) is not satisfied, Vj is recalculated from newly assigned clusters, and the above process is repeated.

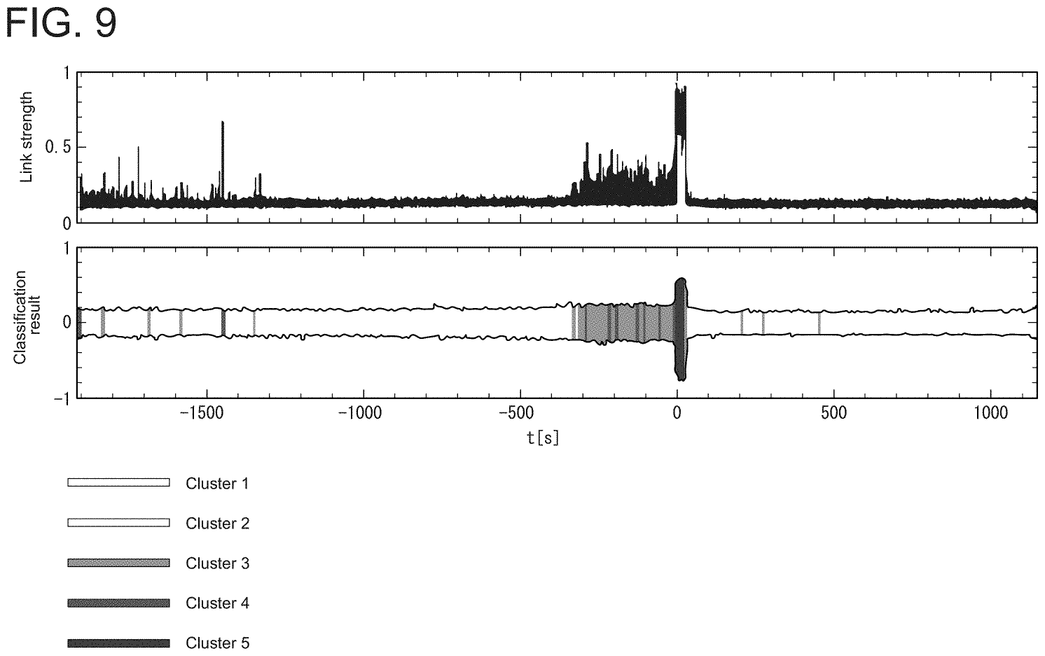

FIG. 9 is an example of a result of clustering changes over time in high-dimensional vector G by the detection unit 130. In this example, the rank changes with the passage of time, and a sign of sudden change vibration can be detected as a rank increase in a stage well before the actual occurrence of sudden change vibration at t=0 (i.e., these five ranks are considered to indicate the combustion state; for example, it can be interpreted that ranks 3 and 4 indicate the transition region, and rank 5 indicates the combustion oscillation region).

In this way, by analyzing the high-dimensional vector calculated from operational data using the determination criterion constructed by learning with teacher data and determining which cluster it belongs to, the detection unit 130 can suitably detect a sign of sudden change vibration.

(Sign Detection Method)

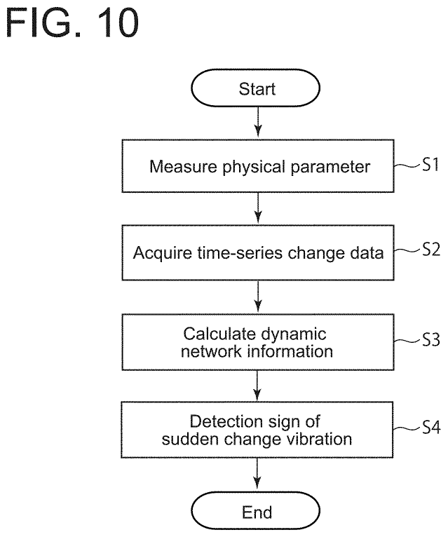

Hereinafter, a specific example of the sign detection method will be described with reference to FIG. 10. FIG. 10 is a flowchart of procedure of the sign detection method according to an embodiment. A part or the whole of the procedure described below may be performed manually by the user. The procedure of the sign detection method described below can be appropriately modified so as to correspond to the process executed by the sign detection device 300. In the following, description overlapping the description of the sign detection device 300 will be omitted.

As shown in FIG. 10, first, the plurality of sensors 200 respectively disposed at the plurality of positions of the detection target measure a physical parameter at each position (step 51). From the plurality of sensors 200, time-series change data of the physical parameter measured by each sensor 200 is acquired (step S2).

Then, dynamic network information representing a time change of a complex network structure including a parameter indicating a correlation between physical parameters at any two positions of the plurality of positions is calculated from the time-series change data (step S3). Then, a sign of sudden change vibration of the detection target is detected based on the dynamic parameter information indicating the correlation calculated in step S3 (step S4).

These steps 51 to S4 may be repeated periodically. Thus, it is possible to monitor a sign of sudden change vibration. If a sign of sudden change vibration is detected, the above-described predetermined signal (stop signal, notification signal, etc.) may be output. Further, the above-described image data may be output, and the image may be displayed on a display device or the like.

The present disclosure is not limited to the embodiments described above, but includes modifications to the embodiments described above, and embodiments composed of combinations of those embodiments.

For example, if the detection target is a compressor, the plurality of sensors 200 for measuring pressure may be arranged at a plurality of positions of the compressor. If the detection target is an axial compressor, the plurality of sensors 200 may be arranged in the circumferential direction of an outlet portion of the compressor. If the detection target is a centrifugal compressor, the plurality of sensors 200 may be arranged in an annular direction. When detecting a sign of sudden change vibration of blade vibrations, the plurality of sensors 200 may be arranged at the root of the blade.

When detecting a sign of sudden change vibration of shaft vibrations, the sensors 200 may be arranged at different bearing positions.

If the detection target is a steam turbine, strain gauges may be used as the sensors 200. For example, the plurality of sensors 200 may be arranged at the roots of blades of the steam turbine arranged along the circumferential direction in the same stage.

If the detection target is a rocket engine, there may be only one combustor. However, even in this case, the plurality of sensors 200 may be arranged in the circumferential direction of an outlet portion of the combustor, and the sign detection device 300 may be configured to detect a sign of sudden change vibration. If the detection target is an aircraft, the method of detecting a sign of sudden change vibration by the sign detection device 300 may be applied to its engines or to its wings. By arranging the plurality of sensors 200 along the circumferential direction in a cross-section at the position where the combustion oscillation occurs, it is possible to detect a sign of sudden change vibration of various detection targets.

In addition, the components in the above-described embodiments may be appropriately replaced with known components without departing from the spirit of the present disclosure, or the above-described embodiments may be appropriately combined.

The contents described in the above embodiments would be understood as follows, for instance.

(1) A sign detection device (300) according to an aspect is provided with: a plurality of sensors (200) respectively disposed at a plurality of positions of a detection target (e.g., gas turbine 20), and configured to measure a physical parameter at each of the plurality of positions; a data acquisition unit (110) configured to acquire time-series change data of the physical parameters from the plurality of sensors; a calculation unit (120) configured to calculate dynamic network information representing a time change of a complex network structure including a parameter indicating a correlation between the physical parameters at any two positions of the plurality of positions, on the basis of the time-series change data; and a detection unit (130) configured to detect a sign of sudden change vibration of the detection target, on the basis of the dynamic network information.

According to the above aspect (1), a sign of sudden change vibration of the detection target is detected based on the dynamic network information representing changes over time in the complex network structure including a parameter indicating a correlation between physical parameters at two positions. Thus, it is possible to detect a sign of the sudden change vibration well in advance of its occurrence.

(2) In another aspect, in the above aspect (1), the time change of the dynamic network information is calculated as a high-dimensional vector constructed based on a plurality of the complex network structures corresponding to successive different times.

According to the above aspect (2), the time change of the dynamic network information used for detecting the sign is calculated as the high-dimensional vector constructed based on the dynamic network information corresponding to successive different times. By considering the dynamic network information corresponding to successive different times in this way, it is possible to suitably detect the sign stage of sudden change vibration, which is difficult to detect with information corresponding to a single time.

(3) In another aspect, in the above aspect (2), the detection unit is configured to detect a sign of sudden change vibration of the detection target, using a classification criterion defining a plurality of clusters previously set based on a possibility of occurrence of the sudden change vibration, on the basis of which of the plurality of clusters the high-dimensional vector is classified into.

According to the above aspect (3), the classification criterion defining a plurality of clusters is prepared in advance based on the possibility of occurrence of sudden change vibration. On the basis of such classification criterion, the detection unit evaluates the possibility of occurrence of sudden change vibration according to which cluster the high-dimensional vector calculated from the detected physical parameters is classified into, and enables the detection at the sign stage.

(4) In another aspect, in the above aspect (3), the classification criterion is set by learning using at least one sample data corresponding to a case where the sudden change vibration occurs in the detection target.

According to the above aspect (4), it is possible to detect the sign with high accuracy by using the classification criterion in which the classification result based on sample data corresponding to the case where the sudden change vibration occurs in the detection target is set as teacher data.

(5) A sign detection method according to an aspect includes: a step of, with a plurality of sensors respectively disposed at a plurality of positions of a detection target, measuring a physical parameter at each of the plurality of positions; a step of acquiring time-series change data of the physical parameters from the plurality of sensors; a step of calculating dynamic network information representing a time change of a complex network structure including a parameter indicating a correlation between the physical parameters at any two positions of the plurality of positions, on the basis of the time-series change data; and a step of detecting a sign of sudden change vibration of the detection target, on the basis of the dynamic network information.

According to the above aspect (5), a sign of sudden change vibration of the detection target is detected based on the dynamic network information representing changes over time in the complex network structure including a parameter indicating a correlation between physical parameters at two positions. Thus, it is possible to detect a sign of the sudden change vibration well in advance of its occurrence.

1. A sign detection device, comprising:
a plurality of sensors respectively disposed at a plurality of positions of a detection target, and configured to measure a physical parameter at each of the plurality of positions;
a data acquisition unit configured to acquire time-series change data of the physical parameters from the plurality of sensors;
a calculation unit configured to calculate dynamic network information representing a time change of a complex network structure including a parameter indicating a correlation between the physical parameters at any two positions of the plurality of positions, on the basis of the time-series change data; and
a detection unit configured to detect a sign of sudden change vibration of the detection target, on the basis of the dynamic network information.

2. The sign detection device according to claim 1,
wherein the time change of the dynamic network information is calculated as a high-dimensional vector constructed based on a plurality of the complex network structures corresponding to successive different times.

3. The sign detection device according to claim 2,
wherein the detection unit is configured to detect a sign of sudden change vibration of the detection target, using a classification criterion defining a plurality of clusters previously set based on a possibility of occurrence of the sudden change vibration, on the basis of which of the plurality of clusters the high-dimensional vector is classified into.

4. The sign detection device according to claim 3,
wherein the classification criterion is set by learning using at least one sample data corresponding to a case where the sudden change vibration occurs in the detection target.

5. A sign detection method, comprising:
a step of, with a plurality of sensors respectively disposed at a plurality of positions of a detection target, measuring a physical parameter at each of the plurality of positions;
a step of acquiring time-series change data of the physical parameters from the plurality of sensors;
a step of calculating dynamic network information representing a time change of a complex network structure including a parameter indicating a correlation between the physical parameters at any two positions of the plurality of positions, on the basis of the time-series change data; and
a step of detecting a sign of sudden change vibration of the detection target, on the basis of the dynamic network information.
